(19) United States
(12) Patent Application Publication
(10) Pub. No.: US 2006/0133454 A1
(43) Pub. Date: Jun. 22, 2006

(54) Wide band interoperable peer to peer wireless systems

(76) Inventor: Robert W. Beckwith, Clearwater, FL (US)

Correspondence Address: Leo J. Aubel, 111 Rivershire Lane, Lincolnshire, IL, 60069, US

(21) Appl. No.: 11/284,239

(22) Filed: Nov. 21, 2005

Related U.S. Application Data
(63) Continuation-in-part of application No. 10/246,941, filed on Sep. 19, 2002, now abandoned.
Application No. 10/246,941 is a continuation-in-part of application No. 09/997,102, filed on Nov. 28, 2001, now abandoned.
(60) Provisional application No. 60/255,046, filed on Dec. 12, 2000.

(51) Int. Cl. H04B 1/707

(52) U.S. Cl. 375/140

(57) ABSTRACT

Intersil HFA processors are used to form peer to peer communications between IEDs in an electric power substation as well as between any IED and a substation access port. IEDs are identified by an 9 bit station identification code for up to 255 IED and a final 9 bit code is given to the access port. Communications is initiated by sending an 9 bit code for a station called followed by an 9 bit code for the station calling. Error checking bits are added to initiating codes forming packets. When a called station receives an error free packet an acknowledgement is sent establishing a peer to peer channel over which bi-directional messages are sent. Longer station identification codes are used to form larger communications systems. Both permanent and movable hubs are used to quickly form large area peer to peer networks in response to an emergency. GPS receivers are used to identify peers and hubs on DeLorme maps. The system in independent of availability of electric power or the internet.

This application is a continuation in part of application Ser. No. 10/246,941 which in turn was a continuation in part of application Ser. No. 09/997,102 which further in turn claimed the priority date of provisional patent application Ser. No. 60/255,046 filed by Robert W. Beckwith on Dec. 12, 2000. Please note the change in title.

### REFERENCES

1. Senate Bill S.1725 by Senator Joe Lieberman and others with amendments dated Sep. 29, 2005. This bill is to be known as: “Assure Emergency and Interoperable Communications for First Responders Act of 2005”.
2. Interoperability n. the ability of a system or component to function effectively with other systems or components. Webster's New World College Dictionary: Fourth Edition.
3. Bill S.1725—The terms ‘interoperable communications’ and ‘communications interoperability’ mean the ability of emergency response providers and relative Federal, State, and local government agencies [personnel] to communicate with each other utilizing information technology systems and radio communications to exchange voice, data, or video with one another on demand, in real time, as necessary.
4. Street Atlas USA by DeLorme, Yarmouth Me., www.delorme.com, U.S. Pat. Nos. 4,972,319 and 5,030,117 cited on Setup compact disc.

### SUMMARY OF THE INVENTION

In a first embodiment of the invention a combination of a portion the Intersil Prism II chip set, herein referred to as HFA processors, was formed with an Atmel processor programmed to replace the Intersil Media Access Controller so as not to avoid data crashes. This combination is used to provide Direct Sequence Spread Spectrum communications operating in the 2.4 Ghz ISM band.

In a second embodiment of the invention a Blackfin BF 537 processor is used with a Chipcon CC2400 2.4 gHz transceiver generating Frequency Hopping Spread Spectrum (FHSS) signals in the 2.4 Ghz ISM band. This adds the capability of sending compressed video and raises the transmitted power level from 30 milliwatts for first embodiment devices to one watt.

The Chipcon device replaces the HFA processors of the first embodiment and eliminates any dependence on IEEE standard 802.11.

A third embodiment is suited for use by electric power company maintenance crews rebuilding power distribution lines to homes and businesses. These maintenance crews work together during the month or more that the rebuilding can take. Agreements to work together extends on a power company to power company basis all across the United States and Canada.

A fourth embodiment of this invention applies in areas where a storm has rendered all communications falling under SEC. 103 of bill S.1725 inoperable; including access to the internet.

This inventive interoperable system provides voice, high speed data and compressed video communications between emergency response providers and Federal, State and local government personnel during a storm. Components are either permanently installed, installed in movable vehicles, or stored in storm proof structures, as required.

Since the inventive system is not dependent on electric utility power, the system is useable during a storm to the extent that the wireless signals function during storm conditions.

After winds and storm surges have past, vehicles containing communications hubs may be removed from storm proof structures and new peer to peer communications systems assembled within hours. People move vehicles, either wheeled or water borne, as required to complete peer to peer communications networks, adding to a permanently installed storm proof backbone peer to peer communications core network. The core network does not depend on electric utility power.

Individuals use laptop computers to locate vehicles or individuals by spots on a DeLorme map covering the area of storm damage and beyond. The spots are created on the DeLorme maps by GPS receivers located on the vehicles or hand held users' transceivers. Users press buttons on their transceivers to locate vehicles or individuals by causing the spots on the DeLorme maps to blink. Calls may then be placed by pushing the button for one second and voice, text messages or compressed video sent in real time to the individuals called.

Using the New Orleans area as an example, storm proof towers at the upper end of Lake Pontchartrain and tops of storm resistant tall buildings in New Orleans hold permanent hubs forming a peer to peer communications backbone. In one or more of these buildings records can be kept of all calls made on the system.

Peer to peer messages are routed automatically, in real time, via combinations of permanent and movable hubs between any two points on the system. Moveable vehicles include wheeled, water borne and air borne, all moved by people. Communications may be made from points on the backbone system to land telephone lines and to cell phones anywhere such systems are operable.

The equipment is very efficient in its use of electric power. Permanently installed hubs may be solar powered. Hubs, moveable by people, are powered by batteries contained in the vehicles forming the hubs. The inventive system and its components are at all times independent of power from electric power lines.

### BRIEF DESCRIPTION OF THE DRAWINGS

FIG. 1 Peer to peer wireless communications within an IED network in an electric power substation.

FIG. 2 A diagram of a wireless transceiver circuit having a non-Intersil MAC with program to control Intersil HFA processors.

FIG. 3 A diagram showing the circuit of a Beckwith Electric model M-2915 device having a Blackfin processor and a Chipcon transceiver providing FHSS communications in the 2.4 gHz ISM band.

FIG. 4 A diagram showing the circuit of a model M-2916 device similar to the M-2915 device further including a GPS input.

FIG. 5 A diagram showing the circuit of a model M-2919 device further including a display and switches as a user interface.

FIG. 6 An RS232 to wireless converter device for use with IEDs or other devices having RS232 ports.

FIG. 7 An SPI to wireless converter device for use with IEDs or other devices having SPI ports.

FIG. 8 A fire-wire to wireless converter device for use with IEDs or other devices having fire-wire ports.

FIG. 9 A USB 2.0 to wireless converter device to use with IEDs or other devices with USB 2.0 ports.

FIG. 10 A Beckwith Electric model M-2950 hub processor, electronic crossbar switch with GPS input.

FIG. 11 A DeLorme map of New Orleans with a scale of 1:800,000.

FIG. 12 A DeLorme map of New Orleans with a scale of 1:400,000.

FIG. 13 A DeLorme map of New Orleans with a scale of 1:25,000.

FIG. 14 A view of the Beckwith Electric model M-2919 device, having the circuit of FIG. 5, for the mayor to communicate wirelessly with his van.

FIG. 15 shows an IBM Thinkpad computer with JVC camcorder and an M-2919 transceiver.

### DESCRIPTION OF THE EMBODIMENTS

### First Embodiment

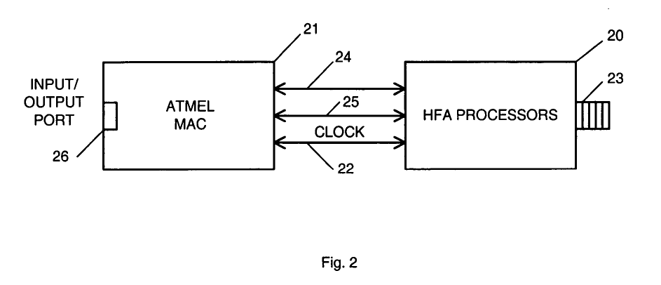

In year 2000, Beckwith Electric Company (BECO) bought the rights to use the Intersil Prism II chip set from the Harris Corporation, the owner of Intersil at that time. This set was for digital communications in the 2.4 gHz ISM band in accordance with IEEE standard 802.11 including withholding transmissions that would result in data crashes. FIG. 2 illustrates the first embodiment of this invention which used said integrated set of Intersil chips but with the Intersil Media Access Controller (MAC) replaced by a non-Intersil Atmel controller. The Atmel processor is programmed as a MAC to control the remaining Intersil chips so as to ignore data crashes. These remaining Intersil chips include a baseband processor, a bi-directional intermediate frequency (IF) DSSS modulator, a bi-directional IF to RF frequency converter for raising the operating frequency into the 2.4 gHz range, an RF amplifier and a solid state transmit/receive switch. These remaining Intersil chips are collectively referred to herein as HFA processors. Unfortunately these remaining Intersil chips, adhering to somewhat hidden 802.11 rules, make programming of the first embodiment product difficult.

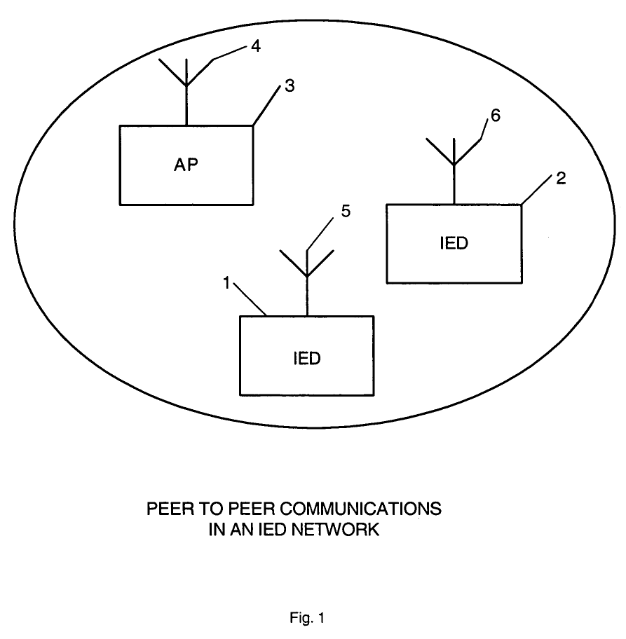

FIG. 1 illustrates an electric power substation communications network showing two typical Intelligent Electronic Devices (IEDs) 1 and 2 having antennae 5 and 6 and an Access Port (AP) 3 with antenna 4. Peer to peer communications between the IEDs 1 and 2 is provided as well as between said IEDs 1 and 2 and an Access Port (AP) 3. The AP is typically connected to an external communications network. Since 2⁹=512, up to 511 nine bit station identity codes are assigned to IEDs. A nine bit identity code may also be assigned to an AP thus possibly using all 512 identity codes provided by the choice of nine bits per identity code.

Peer to peer communications between IEDs 1 and 2 is provided as well as between said IEDs and an AP 3 from said substation to external communications networks, not shown. Devices based on the present invention are capable of establishing wireless connections which are transparent to the structure of IED communication protocols thereby truly replacing wires for digital communications. Two way digital data can be exchanged over the system at a selected one megabit per second bit rate with a typical overhead of 40% yielding a payload bit rate of 600 kilobits per second. The typical payload bit rate is for use with many short messages where the initial routing messages must be used to establish the communication path for each short message. When used for long messages, as for example downloading a past month or more of IED history data or for continuous transmission of a compressed video signal, the payload rate is 100% at one megabit per second once the route has been established.

All Beckwith Electric wireless communications products are marked with the trademark BluJay™ using Cooper Black type font.

Payload is defined as useful messages other than the routing messages used for establishing communications between two peers.

Use of more or less than nine bits per identity code may be useful in managing communications within several interconnected peer to peer networks. For example selected bit codes lengths could be assigned to persons having special responsibilities not wishing to be available to persons in other networks.

The inventive combination is manufactured using a silicon germanium substrate, as recommended by Intersil, capable of supporting the high frequency output of the combination operating in the Industrial, Scientific and Medical (ISM) band from 2.4 to 2.4835 gHz reserved for use by devices rated by design not to require an FCC license for each application.

FIG. 2 shows a 44 mHz clock signal 22 from HFA processors 20 connected to non Intersil MAC 21 to allow for synchronous signals to pass between the two.

MAC 21 has directional serial input output connections 24 and 25 to HFA processors 20. MAC 21 also has a two way clock connection 22 to HFA processors 20 allowing synchronous communications between MAC 21 and HFA processors 20.

HFA processors 20 have a coaxial connector 23 for connecting to antennae either stub or directional.

MAC 21 has input output ports 26. Selectively this may be an SPI or an RS 232 connection.

The establishment of a two way peer to peer channel and the sending of data over that channel use procedures that are built into the architecture of HFA processors 20 in compliance with IEEE standard 802.11. The procedures that avoid data crashes are not used.

Routing packets are used for routing communications packets. The routing code packet includes the 9 bit code of the station being called followed by the 9 bit code of the calling station. Sixteen bits are typically added to the routing code packet for error checking by a receiving station using cyclic error checking.

When a receiving station receives a routing code that is valid it returns its identity code to indicate receipt of a valid routing packet. If the acknowledgement is not received in a specified time the calling station repeats the sending of a routing packet. The specified time is calculated as the maximum time for the sending station to make all attempts to send the packet. The repetition is continued until the receiving station acknowledges receipt of an error free packet.

All IEDs in a network as defined by FIG. 1 above receive the routing packets. As soon as a particular IED receives a routing packet, determines that the packet is error free and that the initial nine bit code is that of the particular IED, then that particular IED acknowledges receipt by returning its assigned 9 bit identity code thus establishing peer to peer communications between IED stations. Once an attempt to send a routing packet is acknowledged as received no further attempts to send the routing packet are made. The sending of data packets then proceeds either between two IEDs or between an IED and the access port.

The data packets are ignored by all but the designated receiving station. The receiving station determines that each packet is error free and if not requests the calling station to send the packet again.

The calling station can request data to be returned by the station called.

Experience has shown that channels perform error free for any range above that set by the receive sensitivity of the HFA processors 20.

In practice, using devices constructed in accordance with this embodiment, it has been found that two way digital messages can be exchanged at a bit rate of one megabit per second with a typical overhead for routing the data of 40% yielding a payload bit rate of 600 kilobits per second.

Message traffic management is used with the inventive system to avoid unnecessary wireless transmissions. IED events that are known to operate infrequently are only reported when they change state. An example is a step change of a voltage regulating transformer tap switch position automatically occurring by operation of a voltage sensing tap-switch control.

Selectively codes of other lengths than nine are used for groups of more and less than 512 total devices.

### Second Embodiment

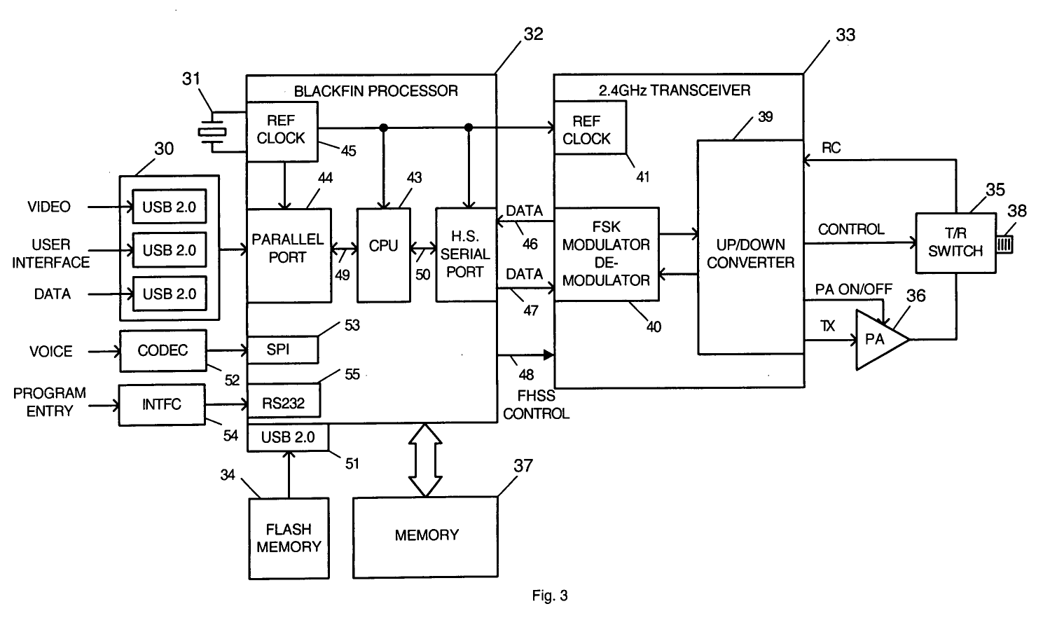

FIG. 3 shows a second embodiment of the invention using a Blackfin BF 537 processor for sending and receiving messages with a Chipcon CC2400 2.4 gHz transceiver generating Frequency Hopping Spread Spectrum (FHSS) signals and moving those signals up to and down from the 2.4 Ghz ISM band. This adds the capability of sending compressed video and raises the transmitted power level from 30 milliwatts for first embodiment devices to one watt.

The Chipcon device replaces the HFA processors of the first embodiment and eliminates any dependence on IEEE standard 802.11.

Note that several processors are available for sending and receiving messages, with the Blackfin processor as the preferred choice. No other transceiver is available, however, for moving signals up to and down from the 2.4 gHz ISM band that is free from dependence on IEEE Standard 802.11.

FIG. 3 shows the circuit diagram of the second embodiment of this invention given the Beckwith Electric Company model number M-2915. The primary purpose of this improved embodiment is to replace devices of the first embodiment.

Blackfin BF537 processors 32 produced by Analog Devices Co. are combined with Chipcon CC2400 2.4 gHz transceivers 33 for wireless communications of voice, data, and video signals. Processors 32 have 64 kilobits of RAM memory on board. Additional volatile and non volatile memory 37 is shown as bus interconnected with processor 32.

Operating programs are used in processor 32 to send and receive messages as well as to control transceiver 33. Transceiver 33 operations are all by built in circuits and logic and contain no programmable functions.

Binary data signals from processor 32 connect to transceiver 33 via two directional connections, one 46 into processor 32 and a second 47 out of processor 32. Parallel port 44 is connected to CPU 43 via bi-directional connections 49 and CPU 43 is connected to High Speed serial port 42 via bi-directional connections 50.

Crystal 31 is converted into reference clock 45 in processor 32. Reference clock 45 is connected to CPU 43, to H.S. serial port 42 and to ref clock 41 in transceiver 33. The connection of reference clocks 45 and 41 cause processor 32 and transceiver 33 to operate at the same frequency permitting data transmissions to be made synchronously.

Memory 37 is bus connected to processor 32, containing both volatile and non volatile memory as required for processor 32 operation.

Flash memory 34 is connected via port 51 to processor 32. This is useful for storing compressed video for later use. Selectively port 51 is either a USB 2.0 or a memory card insertion socket.

Video signals are input to processor 32 via the top USB 2.0 port of USB expander chip 30.

Video signals from the preferred JVC GZ-MG20U hard disk camcorder 151, in the preferred economy mode, are 1.5 megabits per second. The Chipcon CC2400 2.4 gHz transceiver 33, on the other hand, has a stated bandwidth of 1.0 megabits per second. The second embodiment of FIG. 3 will thereby have the mismatch between camcorder 151 data rates and the transceiver bandwidths. The resultant degradation of video picture quality will be tolerated.

When wireless transmission of video signals is not required, the camcorder 151 can be used to store data on the hard drive in the highest definition mode. The video can then be viewed by using an S-video cable 151 connection from the camcorder 151 to any TV receiver having an S-video port.

User interface, normally from a lap top or other portable computer, enters processor 32 through the center of three ports in USB 2.0 expander chip 30.

Digital data, often from a document scanner, enters processor 32 through the bottom USB 2.0 port of USB 2.0 expander chip 30.

In one form voice is sent as a component of the video and requires no special processing other than that described above for the video.

Voice from a separate microphone, on the other hand, is passed through a Philips UDA 1345TS CODEC device 52 to serial peripheral interface SPI 53 of processor 32.

Program Entry, normally a factory operation at time of manufacture, passes from a computer, not shown, through interface device INTFC 54, for matching of voltage levels, to RS232 port 55 of processor 32.

Transceiver 33 has up/down frequency converter 39, FSK modulator demodulator 40 and reference clock 41.

Transceiver 33 converter 39 receives messages via connection RC from transmit/receive (T/R) switch 35. T/R switch 35 receives messages picked up by selected antennae, not shown, connected to T/R switch 35 by coaxial cables, not shown, from antennae to coaxial connector 38. These antennae may be selected as quarter wave stubs or as various forms of directional antennae.

Converter 39 transmits messages via connection TX to power amplifier 36. Power amplifier 36 is turned on for transmission and off for reception by connection labeled PA ON/OFF from converter 39. Preferably PA 36 delivers one watt of power, through switch 35, to any antennae connected by coaxial cable to coaxial connector 38.

Received signals pass through coaxial connector 38, on through T/R switch 35, switched to the receive direction by connection CONTROL, and to converter 39 via connection RC.

Chip 30 contains three USB 2.0 drivers with a common parallel connection to parallel port 44. Video signals go to parallel port 44 via USB 2.0 device 30, to CPU by connection 49, to H.S. serial port 42 and to FSK modulator 40. Frequency Hopping Spread Spectrum (FHSS) control 48 passes from processor 32 to transducer 33.

Compressed 1.5 megabit video bandwidth signals from JVC G2-MGOU camcorders 151 are connected to processor 32 via a USB 2.0 input. Horizontal video picture lines are synchronized with the FHSS hopping rate, using FHSS Control 48. Programs in processor 32 prevent herringbone distortion of the video signal entering transceiver 39. The herringbone distortion occurs should a hop from one frequency to another occur during a horizontal scan of the video picture. The synchronization permits the switching of hopping frequencies to occur only between horizontal picture scans.

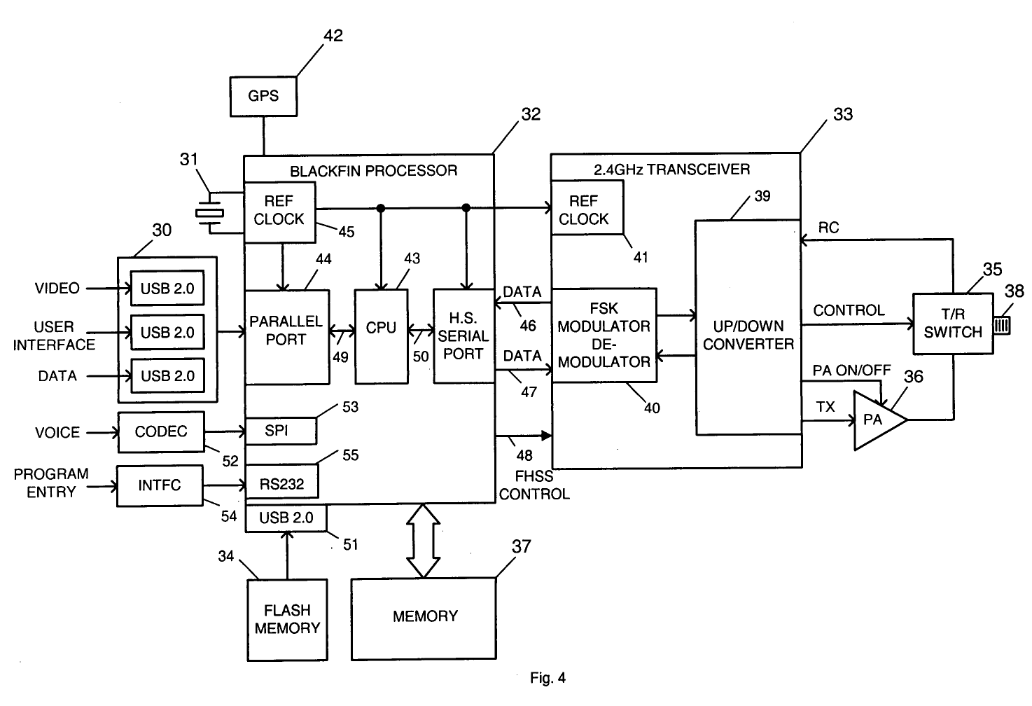

Compressed video signals can pass through additional M-2915 or M-2916 devices as described by FIGS. 3 and 4 without further distortion with re-synchronizing of video frames and frequency hopping rates occurring each time the signal passes through.

### Third Embodiment

This embodiment adds connection devices and a hub for adding to devices of the second embodiment in order to construct a wide area peer to peer communications network.

FIG. 4 shows the circuit diagram of a Beckwith Electric M-2916 device and is the same as FIG. 3 with the addition of the Maxim Integrated L1-Band GPS Receiver. The GPS receiver 42 is connected to processor 32 through a processor 32 binary input port, not shown. Programs in processor 32 demodulate the GPS signal and extract the geographical location coordinates.

The single chip GPS device is but 0.2″ square and costs $4.00 in tape form for pick and place assembly to circuit boards. Since the GPS device can be turned off when not required, it is more economical to manufacture only the M-2916 device with the GPS receivers always included. The M-2916 becomes the major building block for the wideband interoperable peer to peer wireless systems as of the title of this application.

Identity codes are assigned to each peer. The code length is set to accommodate the number of peers expected for a particular application of the M-2916 devices.

The establishment of a two way peer to peer channel proceeds as follows:

1. Routing packets include the identity code of the station being called followed by the identity code of the calling station, further followed by 360 bits GPS location codes for latitude and longitude, each in degrees, minutes, seconds, and tenths of seconds, but only if GPS is turned on.

A selected number of error checking bits, typically 18, are added to the routing packet for use by the station called in determining the validity of routing packets received by using cyclic error checking.

2. When a calling station receives a routing packet that is valid, it returns its identity code to indicate the receipt of a valid routing packet. If the acknowledgement is not received in a specified time, the calling station repeats the sending of a routing packet. The specified time is calculated as the time for sending a routing packet by the calling station, over any network involved.

3. All peers in a network receive the routing packets. As soon as a particular peer receives a routing packet, determines that the packet is error free and the initial identify code is that of the particular peer, then the peer returns its assigned identity code thus becoming a designated receiving station. Once an attempt to send a routing packet is acknowledged as received, no further attempts are made to send the routing packet and the starting of sending data proceeds between the two peers.

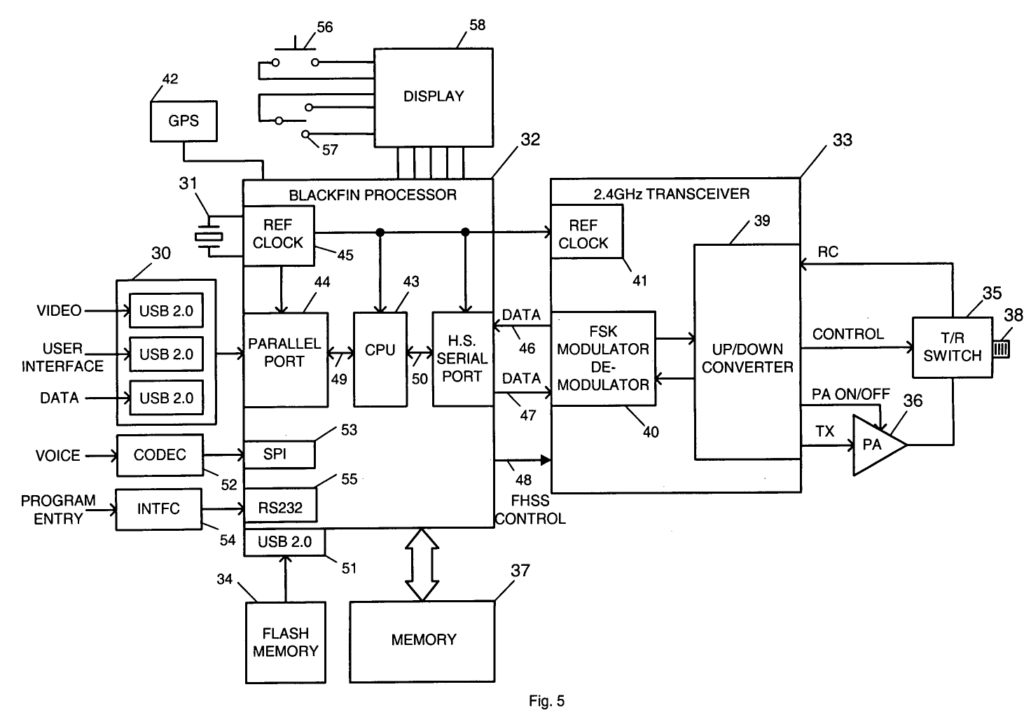

FIG. 5 is the schematic of a Beckwith Electric M-2919 device, the same as M-2916 (FIG. 4) but with the addition of a display 58, push button switch 56 and rocker switch 57, providing a user interface wherever people are directly involved. Operation of rocker switch 57 moves the display 58 up or down for selection of a peer of interest which may be a person or a moveable communications hub. Pushing switch 56 momentarily identifies the location of the peer of interest on a DeLorme map as described below. If a person, pressing the switch for a selected longer time, say one second, places a call to that person wherever located on a peer to peer communications network.

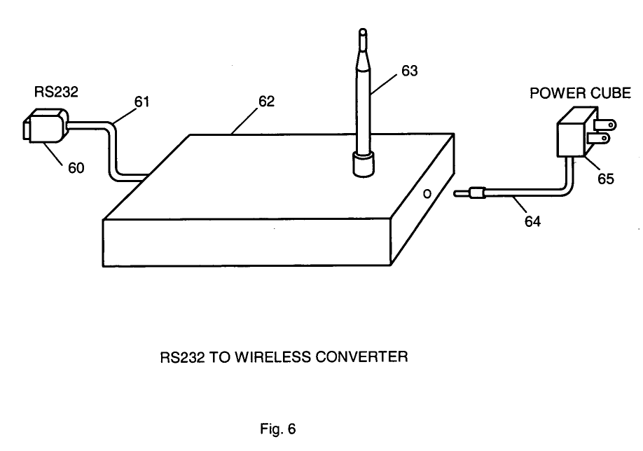

FIG. 6 shows an RS 232 to wireless converter. RS232 connector 60 connects to a USB 2.0 port. Cable 61 connects connector 60 to circuit box 62. Circuit box 62 contains a bi-directional wireless to RS 232 converter handling communicating signals via antenna 63. Power cube 65 cable 64 plugs into box 62 for powering said converter.

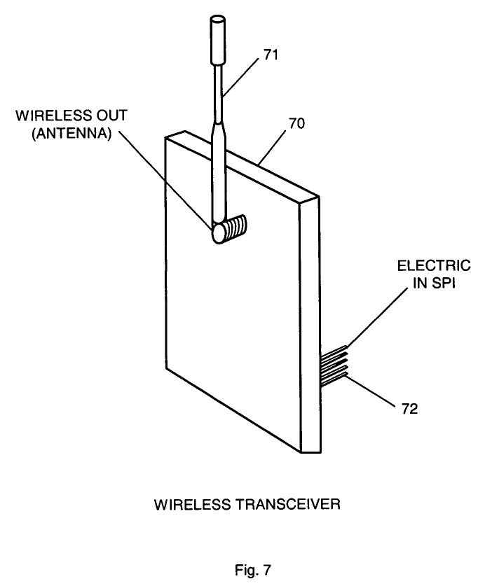

FIG. 7 shows an SPI port 72 to wireless converter handling wireless communications supplied by a communications converter within box 70 via signals handled by antenna 71.

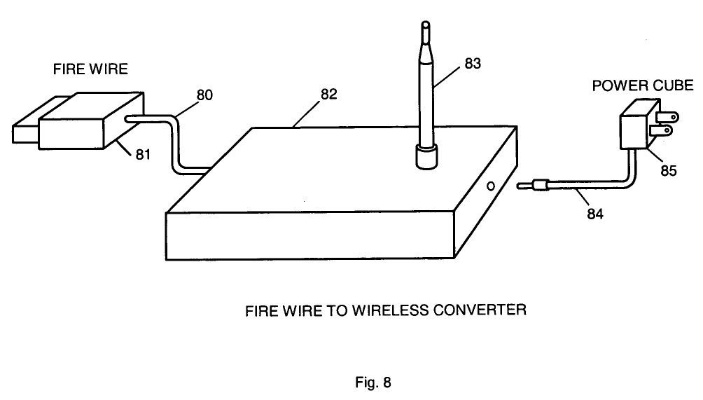

FIG. 8 shows a fire-wire to wireless converter handling wireless communications supplied by a communications converter within box 82 via signals handled by antenna 83 and connected to connector 81 via cable 80. Power cube 85 cable 84 plugs into box 82 for powering said converter.

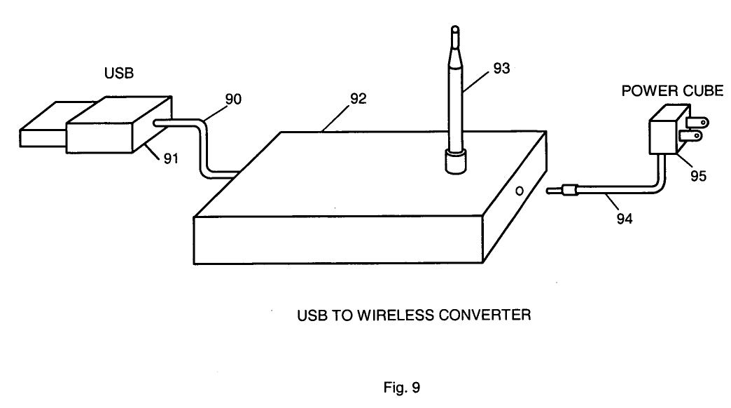

FIG. 9 shows a USB to wireless converter handling wireless communications supplied by a communications converter within box 92 via signals handled by antenna 93 and connected to connector 91 via cable 90. Power cube 95 cable 94 plugs into box 92 for powering said converter.

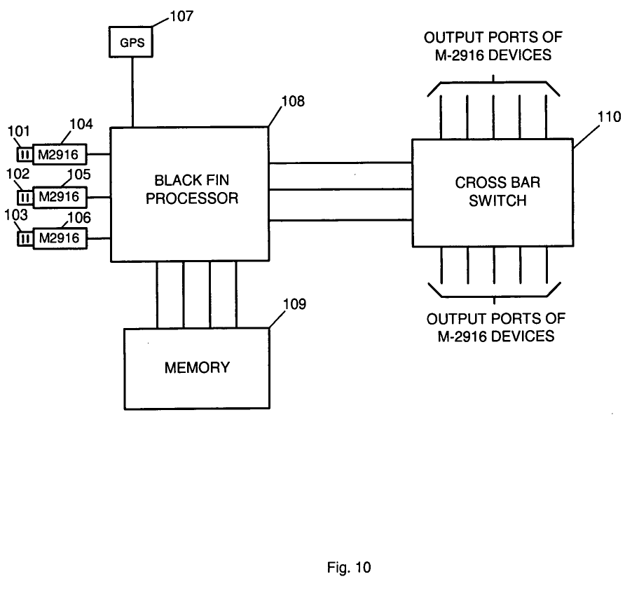

FIG. 10 illustrates the circuit of a hub capable of extending the communications range between peers by a network of such hubs. Blackfin Processor 108 controls solid state cross-bar switch 110. Cross-bar switch 110 connects ports of M-2916 wireless communications devices together as required for communications between peers in a wide area network of peers.

When a peer cannot communicate directly to another peer but must communicate through one or more hubs the routing routine passes through the hubs. When a system is initialized, hubs poll the peers to find their GPS location. After being initialized, hubs use the GPS information to route calls between any two peers requiring use of the hubs. Several of the attempts by the routing routine may be used up in this process.

Routing codes may pass through one or more hubs, the accuracy of the codes determined, and responses sent back as described above.

When GPS signals are used to show the location of a peer, the GPS coordinates of the peers location are added to the routing code after the sending stations identity code. The hubs strip out peer GPS locations and share them in system wide tables. These tables are formed by hub to hub communications typically using M-2916 devices 104, 105, and 106 antennae 102, 102 and 103. Where choices of paths through the hub network exist, the hubs route the routing packets through channels not in use. The size of the hub is chosen to reduce the probability of all cross-bar paths being in use at any one time.

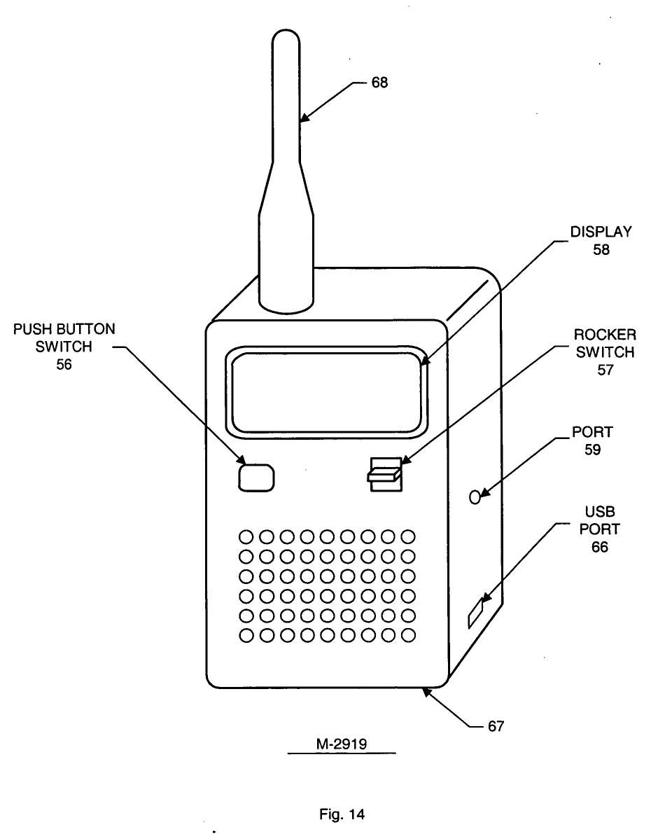

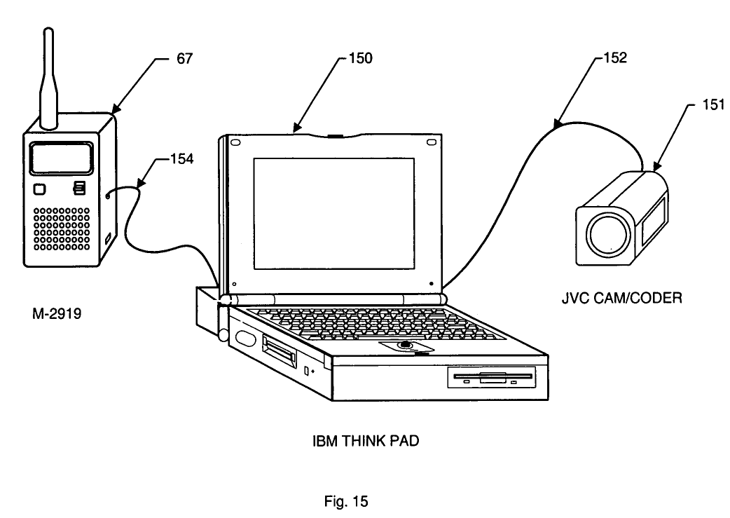

An IBM Thinkpad computer 150 (Please see FIG. 15 below) is preferred for use with the inventive system for communications. The computer is programmed with a DeLorme support program, The computer disk holder has a DeLorme mapping data disc covering all of the U.S.A. A Thinkpad 150 user program holds lists of peer for selective loading into M-2919 devices 67 (see FIG. 14 below) as the owner of the M-2919 device 67 desires. The Thinkpad 150 interfaces with the M-2919 device 67 permitting the user to locate peers on the DeLorme display showing on the users' Thinkpad computer 150.

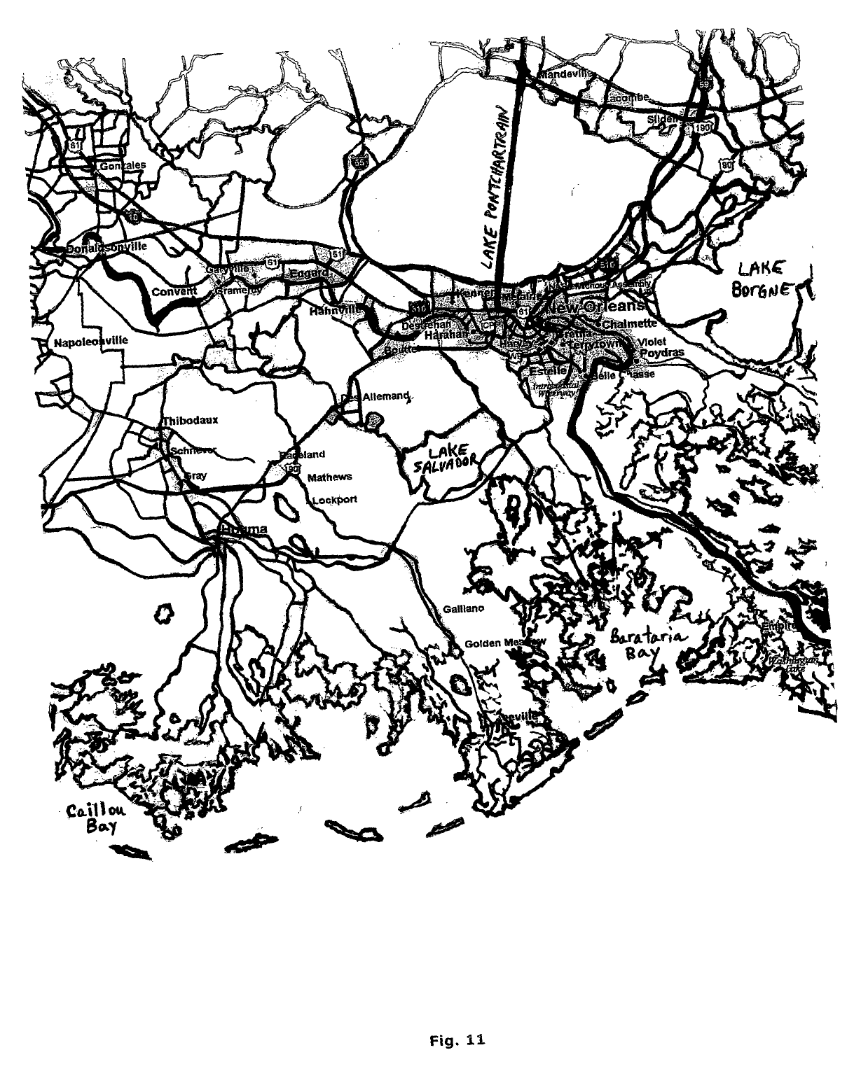

FIG. 11 shows a black and white DeLorme map of the New Orleans area with a scale of 1:800,000 as can be printed out from the computer in color.

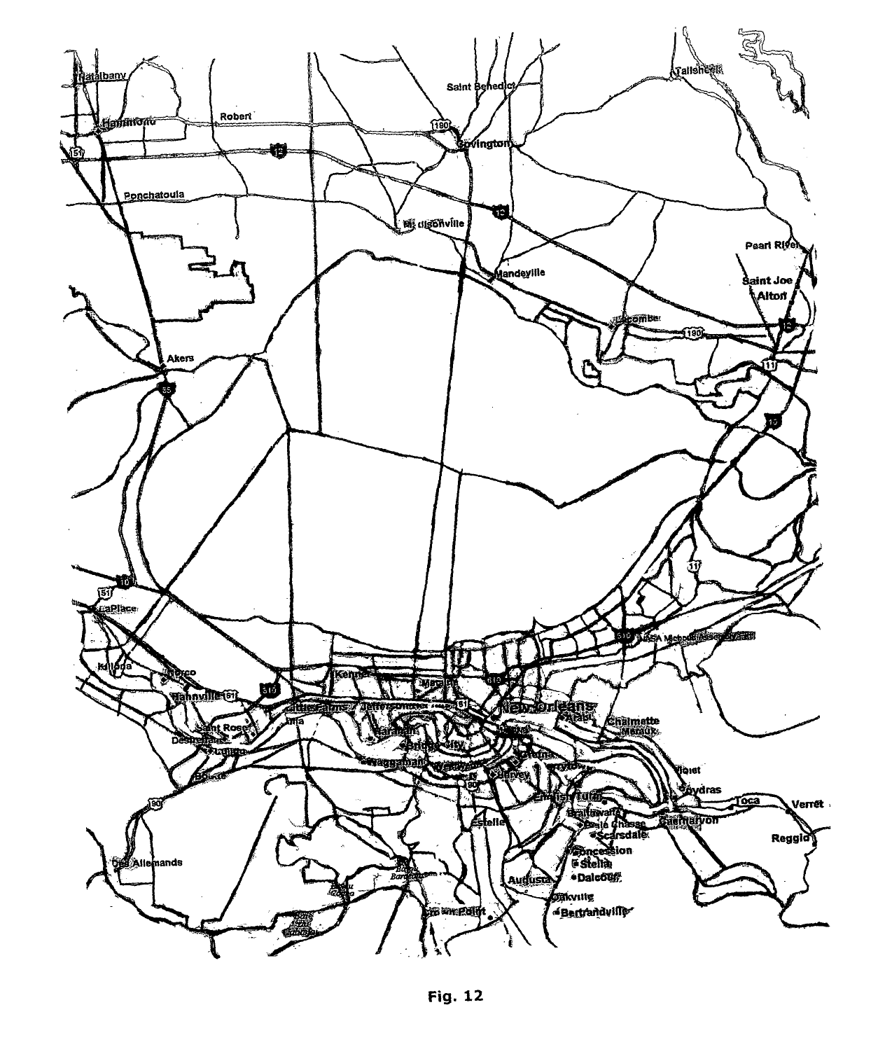

FIG. 12 shows a DeLorme map of the New Orleans area with a scale of 1:400,000.

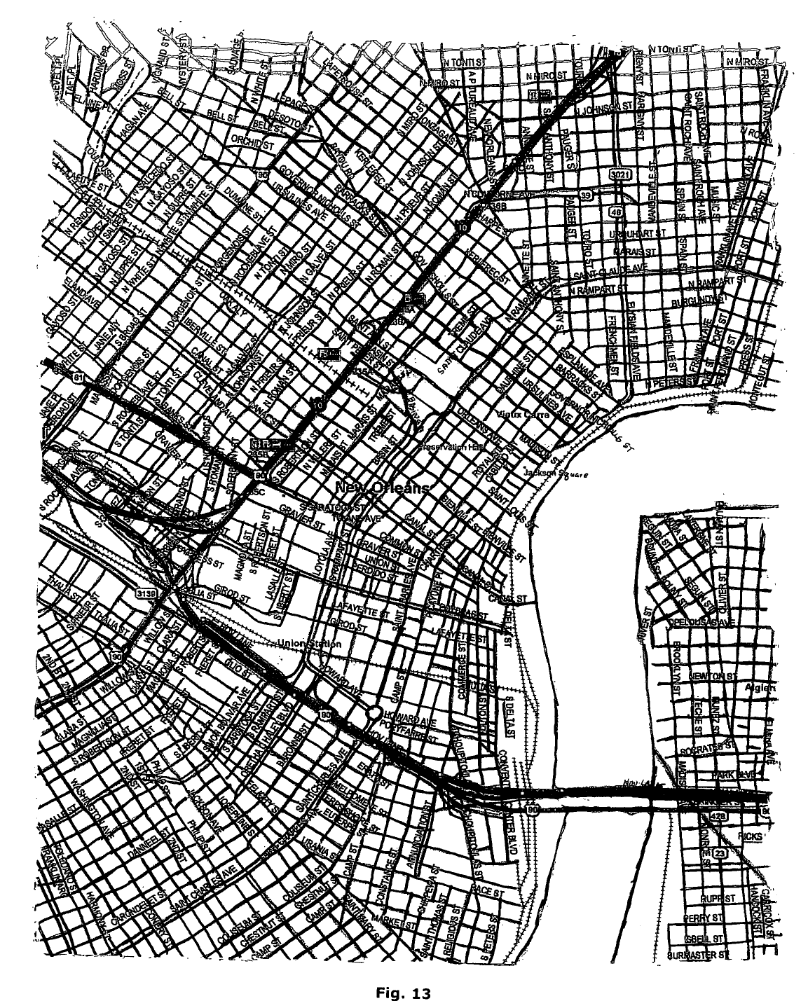

FIG. 13 shows a DeLorme map with a scale of 1:25,000 on which streets in New Orleans and nearby areas can be identified.

FIG. 14 shows the Beckwith Electric Company Model M-2919 transceiver device 67. Note the rocker switch 57 for moving the display 58 of peers up and down. Note also push button switch 56. When pushed briefly a green spot will flash on a DeLorme map contained in a Thinkpad computer 150. Port 59 is for insertion of a combination earphone/microphone device for hands free conversation. This follows common practice with cell phones.

The USB port 66 is for connection of the preferred camcorder 151. Antenna 68 is the stub type of choice for this device.

This embodiment is suited for use by electric power company maintenance crews rebuilding power distribution lines to homes and businesses. These maintenance crews work together during the month or more that the rebuilding can take. Agreements to work together extends on a power company to power company basis all across the United States and Canada. For example, Florida Power worked with Florida Power and Light in restoring lines taken out by hurricane Wilma.

These companies have found that they cannot communicate by cell phone, even if the cell phone system is operable because of overloading of the cell phone system by the large number of users of cell phones. The power company communications is often dependent on their own power. During black out conditions they are often limited to short range communications via battery operated “walkie talkie” radios.

The inventive system of embodiment three is suited to construction of a peer to peer network useable by power line maintenance crews during blackout conditions whether or not caused by storms. It is essential that the public be excluded from such systems.

FIG. 15 shows a combination of IBM Thinkpad computers 150 connected to JVC camcorders 151 and Beckwith Electric Model M-2919 transceivers 67. Camcorders 151 connect by cable 154 to a computer 150 USB 2.0 port. Programs on computer 150 download recorded video from camcorders 151 into files. These files are available to peers for selection and sending to peers via transceiver 67. Continuous video from computer 150 memory can be displayed on computers 150 screens.

Computers 150 have user (peer) programs that allow peers to exchange voice, data, or video with one another on demand, in real time. Peers can also provide video to the news media if authorized to do so.

Computers 150 also contain DeLorme programs permitting maps to be displayed on computer 150 screens. Peers may be located on said maps.

The system of FIG. 15 is the preferred form of this invention.

### Fourth Embodiment in Response to Bill S.1725

Section 102.FINDINGS paragraph (4) of Bill S 1725 states: “(4) A further major barrier to sharing information among police, firefighters, and others who may be called on to respond to natural disasters, terrorist attacks, and other large-scale emergencies is the lack of interoperable communications systems, which can enable public safety agencies to talk to one another and share important, sometimes critical information in an emergency. Police and firefighters responding to the attacks at the World Trade Center on Sep. 11, 2001, had difficulty communicating with each other. Initial press reports indicate that conflicting radio frequencies also contributed to the difficulties in communications among law enforcement and government relief agencies in communications among law enforcement and government relief agencies in the aftermath of Hurricane Katrina.”

In this embodiment of this invention, in response to the above findings of Bill 1725, applicant offers a stand alone, self sufficient system that provides peer to peer communications in areas suffering loss of ordinary telecommunications infrastructure, including the internet, and sustained loss of electricity.

This embodiment uses the large area peer to peer network describes under embodiment three. Peers can exchange voice, data, or compressed video with one another on demand, in real time, as necessary.

The video camera of choice is the JVC Everio GZ-MG20US. This camera is hand held, weighing less than 14 oz. with battery attached. A 20 gigabit hard drive is contained in the camera for recording 4.5 hours of video in MPEG-2 digital format. This mode is useful when wireless transmission of the video signal is not required. With video camera operation in the preferred economy mode, seven hours can be recorded and played back over a wireless circuit. An S-video cable 151 can be used between the camera and any TV receiver with an S-video port to play back the recorded video of either mode.

A zoom lens enlarges images 25 times without jagged edges. Images can be enlarged up to 800 times with combination of digital and zoom lens enlargement.

The camera can be connected by a USB cable to the video input to USB 2.0 as shown in FIG. 14. The camera can also be connected to the USB 2.0 port of any computer with such a port and continuous video from the camera memory displayed on the computer screen.

The frequency hopping of outputs from transceiver 33 is controlled by processor 32 and synchronized with the picture lines coming from the economy mode of the camera so as to eliminate herringbone picture distortion. The synchronization prevents a frequency hop from occurring during the time duration of picture lines thus causing the herringbone distortion.

Such processed video of any time duration can be sent by any peer to another peer in a network including hubs. The receiving peer displays the received video on an IBM Thinkpad computer 150 or by an S-video connection to a TV receiver.

The received video can also be recorded by the receiving peer on the Flash Memory 34. The flash memory 34 can be unplugged and carried to any compatible device for display.

This embodiment prefers a 14 bit station identity codes to provide for as many as 16,384 peers.

Communication components are linked together by communication hubs into interoperable peer to peer networks. Communications components and networking vehicles are stored in storm proof bunkers. After a storm, surviving personnel remove components and vehicles from bunkers and form peer to peer communications networks as needed.

Vehicles are moved by the personnel reforming networks as made necessary by a continuously changing search, rescue and restoration operation. Twelve volt batteries in the vehicles become the common power source for the network. Hand held communications components, stored in the bunker, are issued to emergency response providers and relative Federal, State, and local government agency personnel.

IBM Thinkpad computers 150 are stored in the bunkers. These are for use as user interface devices to set peer and hub station identifier codes and other setpoints required for initializing the equipment.

The resultant components and networks will have the ability to handle streaming text messages, single color pictures and full color compressed video.

Wireless messages are sent and received by stub or directional antennae, not shown, connected via coaxial connector 38 to converter 39.

Referring again to FIG. 5 which is the schematic of a Beckwith Electric M-2919 device, the same as M-2916 but with the addition of a display 58, push button switch 56 and rocker switch 57, providing a user interface wherever people are directly involved.

Rocker switch 57 is used by a peer to move the display up and down a list of peers. Once a desired peer is identified on the display, pushing button 56 momentarily will cause a spot on a Delorme map on the calling peers' IBM Thinkpad computer 150 to blink, indicating the desired peers' location. The calling peer can then initiate a call by pushing switch 56 for one second. The call is automatically routed through any hubs necessary to complete the connection. When a call is received from a peer the caller's spot will flash on the map and his identity will show on the receiving peers display.

Hubs have GPS receivers for reporting the locations of hubs as they are moved. Hubs are interconnected with pairs of M-2916 modules for exchange of routing information for calls between peers not able to communicate without a hub.

The hubs monitor all calls and read GPS position codes included in call routing messages. Maps are formed, using DeLorme programs, all continually updated and ubiquitous to users calls.

A routing code has the 14 bit station called ID code followed by the 14 bit station calling ID code followed by a 360 bit GPS station location code. All codes are preceded by a uniform wake up code for the Blackfin processor after which codes are separated by merely counting bits.

M-2916 modules communicating between hubs also carry map-making information and routing information to connect peer to peer links at hubs permitting communications anywhere in the area for which hubs are provided.

Peers can use communications modules during a storm to monitor another peers status whenever conditions permit. The monitoring transceiver could be mounted in the storm-proof bunker. Any peers transceiver lost by storm action can be replaced after the storm is over and the bunker can be opened.

When the calling switch is pressed on a M-2919 device, all peers in a local peer to peer network receive routing packets. As soon as a particular peer receives a routing packet, determines that the packet is error free and that the initial 14 bit identity code is that of the particular peer, then that particular peer acknowledges receipt by returning its assigned 14 bit identity code thus becoming a designated receiving station. Once an attempt to send a routing packet is acknowledged as received no further attempts are made and the starting of sending data packets proceeds.

Hardening the System Before a Hurricane

Using the New Orleans area as an example, storm proof towers at the upper end of Lake Pontchartrain and tops of storm resistant tall buildings in New Orleans hold permanent hubs forming a peer to peer communications backbone. An M-2916 device on the storm proof tower at the upper end of Lake Pontchartrain drives a directional antenna pointing towards the tall buildings in New Orleans. M-2916 devices at the hubs on tall buildings drive directional antennae pointed towards the storm proof tower at the upper end of Lake pontchartrain. Other such intercommunication links tie the tall buildings together forming as many links between buildings as possible thus creating a permanent storm proof peer to peer communications backbone.

In one or more of these buildings records can be kept of all calls made on the system.

A number of M-2916 devices are assembled into a peer to peer connection hub as described by FIG. 10. A selected number of modules are assigned user identity codes for peers expected to be near the hub after the storm passes. Another selected number of modules are assigned identity codes for assignment to other connection hubs.

Some hubs are mounted in dry land vehicles to operate in terrain expected to be dry of any flooding after a storm passes. Others are mounted on vehicles capable of travel on wheels through water of a chosen depth. Still others are mounted on water boats propelled by any means available.

All vehicles are mounted in a hurricane proof building or buildings at selected high elevation locations throughout an area to be served by first response personnel. The vehicles form a network capable of fast change by first response personnel as recovery operations change.

Hardened structures protecting the vehicles will store a number of communications devices for use by first response providers and Federal, State and local government agency personnel should they not already have devices in their possession. It is important that the system is not encumbered by a necessity to be compatible with any existing communications equipment but only interoperably compatible with itself.

One item is common throughout the systems and that is the 12 volt car, truck and other vehicles involved. These batteries become the source of power for the communications system.

FIG. 10 shows the electrical design of a hub. All hubs are identical and have programs for routing traffic around any hub that is out of service.

Antennae 101, 102, and 103 are directional antennae directed toward other hubs connected to hub processor 108 via M-2916 communication devices 104, 105 and 106. These circuits exchange DeLorme map interconnection information between hubs. They also handle network traffic information for linking peer to peer stations thus establishing an extended routing packet procedure for establishing communications between peers located by GPS signals as requiring communication through one or more hubs. Blackfin BF 537 processors 108 perform all of the computations required at hubs. Non volatile memories 109 are connected in parallel to processor 108 busses.

Processors 108 are connected to electronic crossbar switches 110. These electronic crossbar switches connect FIG. 3 device input-output ports as required to link peer to peer communications calls through hubs as required for the peers to communicate.

Advantages of the Invention

1. The invention does not depend on existing communication means.

2. Embodiments two and higher are independent of IEEE standard 802.11.

3. The inventive transmitters deliver one watt to the antennae for maximum utilization of the inventive equipment which will not require FCC approval or license for each unit.

4. The power use efficiency is high with only 5 watts estimated to supply each transceiver.

5. Equipment will operate from 12 volt car or truck batteries, 24 and 48 volt aircraft batteries or from solar power. The equipment is in no way dependent on electric utility power, but can be used for convenience when available.

6. Highly efficient dc/dc converters from 12 volt batteries to 7.2 volts for the camera and to 3 volts for other equipment, will be available.

7. Peers may communicate by voice, high speed text, color pictures and video clips.

8. Peers may communicate between any points in a large area along the gulf coast with calls automatically automated.

9. Peers are located by GPS on a DeLorme map continually updated each time a peer communicates.

10. Videos may be provided to the press as desired by managers of the emergency response team.

11. Modules may be assembled into hubs in the field with minimal training.

12. Modular components are small in size reasonable in cost.

13. Emergency response providers and Federal, State and local government agency personnel may enter the net by being furnished a BluJay™ transceiver.

14. In areas where all land line and cell phone systems have been made inoperable by a storm and the inventive stand alone system described herein is the only existing communications, calls may be made to operational land lines and cell phones outside the devastated area.

15. The number of peers on the inventive network is limited by design to some 16,000 and by user assignment to peers numbering less than 16,000. The inventive network avoids overload blocking by careful assignment of station identity codes to a limited number of individuals with assigned tasks in a recovery operation. Others suggest a robust cell phone network which surely will rapidly overload by the millions of cell phone users.

16. A nationwide network can be constructed-permitting electric power company maintenance crews to communicate with or without electric power and with persons not requiring communications excluded from the electric power company network.

17. None of the devices or systems of this invention are required to follow requirements of IEEE Standard 802.11.

18. Low cost power converters are available for charging camcorder 151 batteries either by plugging into the cigarette lighter socket of a car or truck or by plugging into a 120 volt electrical socket when power is available.

19. Batteries are available at reasonable cost permitting quick change when a camcorder 151 battery runs low.

1. A method of using Intersil Prism II chip sets for digital communications in the 2.4 gHz ISM band between IED stations in electric power substations having access ports, the method comprising the steps of:
a) replacing Intersil Prism II Media Access Controllers (MACs) with Atmel MACs, and
b) programming said Atmel MACs for controlling the remaining Intersil chips so as to ignore data crashes.

2. A method as in claim 1 further including the following steps:
a) assigning nine bit identity codes to said IED stations,
b) establishing peer to peer communications by forming routing packets,
c) including identity codes of stations called followed by identity codes of stations calling when forming routing packets,
d) adding cyclic error checking bits to said routing packets,
e) receiving stations checking routing packets for errors,
f) returning receiving station identity codes upon receiving error free routing packets, and
g) calling stations and receiving stations exchanging messages.

3. A method as in claim 2 further comprising the steps of:
a) assigning nine bit identity codes to said access ports, and
b) using the same procedures for establishing peer to peer communications from IED stations to access ports as established between IED stations.

4. A method of establishing peer to peer communication networks of IEDs within electric power substations with access ports, the method comprising the steps of:
a) using Blackfin BF537 processors and Chipcon CC2400 transceivers for providing FHSS communications in the 2.4 gHz ISM band,
b) assigning nine bit identity codes to IED stations,
c) establishing peer to peer communications by forming routing packets,
e) including identity codes of stations called followed by identity codes of stations calling when forming routing packets,
f) adding cyclic error checking bits to said routing packets,
g) receiving stations checking routing packets for errors,
h) returning receiving stations identity codes upon receiving error free routing packets, and
i) calling stations and receiving stations exchanging messages.

5. A method as in claim 4 further comprising the steps of:
a) assigning nine bit identity codes for said access ports, and
b) using the same procedures for establishing peer to peer communications between said IEDs and said access ports as used for establishing peer to peer communications between IED stations.

6. A method of sending video signals within peer to peer networks, the method comprising the steps of:
a) recording video in low bandwidth using JVC camcorders in the economy mode,
b) receiving recorded video from said camcorders using IBM Thinkpad computers,
c) converting video into memory files in said computers, and
d) exchanging videos between peers by using data from said computers memory files.

7. A method as in claim 4 comprising the further step of operating single horizontal scan lines of said compressed video signals in synchronism with the frequency hops of said Chipcon transceivers so as to prohibit frequency hops during a scan line.

8. A method of sending voice, high speed data and video in real time the method consisting of the steps of:
a) using Blackfin processors for sending and receiving messages,
b) using Chipcon transceivers for converting messages up to and down from the 2.4 gHz ISM band,
c) obtaining compressed video signals with voice from IBM Thinkpad computers memories,
d) connecting compressed video signals with voice via USB 2.0 ports to said Blackfin processors,
e) connecting alternate microphones via codec devices to said Blackfin processors,
f) connecting high speed data via USB 2.0 ports to said Blackfin processors, and
g) selecting voice, data or video by using IBM Thinkpad computers, whereby voice, data and video can be selected in real time as required.

9. A method as in claim 8 having the further steps of:
a) providing GPS inputs to said Blackfin processors,
b) providing DeLorme programs and data disks for said Thinkpad computers, and
c) displaying GPS locations of peers on said computer screens.

10. A method of providing wireless communications comprising the steps of:
a) using Blackfin processors for sending and receiving messages, and
b) using Chipcon CC2400 transceivers for raising messages up to and lowering messages down from the 2.4 gHz ISM band
whereby the rules of IEEE Standard 802.11 are avoided.

11. A method for users to exchange of voice, data, or video with one another on demand and in real time, the method comprising the steps of:
a) users interfacing with IBM Thinkpad computers,
b) users recording video with voice on JVC hard disk camcorders,
c) interconnecting said computers and camcorders with cables,
d) exchanging voice, data and video using Beckwith Electric M-2916 transceivers,
e) interconnecting said M-2916 transceivers and said computers using DVD cables,
f) exchanging voice with said computers,
g) exchanging data between said computers, and
h) exchanging recorded video from said computers memories all on demand and in real time.

12. A method of using Beckwith Electric Model M-2916 transceivers to form large area peer to peer networks, the method comprising the following steps:
a) forming communication hubs using a number of M-2916 devices,
b) communicating to remote M-2916 devices using choices of antennae,
c) locating said remote M-2916 devices at other hubs for providing a hub to hub network,
d) routing calls through hubs through solid state cross bar switches, and
e) forming wide area peer to peer networks by using hubs.

13. A method as in claim 12 further comprising the steps of:
a) including GPS devices for determining the geographic locations of said hubs,
b) including identity codes of stations called followed by identity codes of stations calling followed by GPS coordinates of the station calling when forming routing packets,
c) hubs communicating with each other on a wide area basis,
d) hubs stripping out peers identity and location, and
e) hubs making peers identity and location data available on a network wide basis.
